(19) United States
(12) Patent Application Publication
(10) Pub. No.: US 2018/0264294 A1
(43) Pub. Date: Sep. 20, 2018

(54) Fit and Function Face Mask Apparatus

(71) Applicants: Jeffrey Dennis Hancock, Uintah, UT (US); Christopher Nielson Schenck, Uintah, UT (US)

(72) Inventors: Jeffrey Dennis Hancock, Uintah, UT (US); Christopher Nielson Schenck, Uintah, UT (US)

(21) Appl. No.: 15/462,543

(22) Filed: Mar. 17, 2017

(51) Int. Cl. A62B 18/02; A62B 18/08; A62B 23/02

(52) U.S. Cl. CPC A62B 18/025; A62B 23/02; A62B 18/084

(57) ABSTRACT

An improved fit and function mask type apparatus. The mask system incorporates a flexible outer body constructed of fabric that provides the general shape and structure of the mask. The upper portion of the mask features a three-dimensional nose pocket that is integrated into the mask and is made from a separate piece of material. This upper nose pocket structure has no seam where it contours over the nose. The material in the structure past the Apex of the nose is split and then joined together to form a seam. This seam extends downward from the contoured section and in front of the nose. The non-seamed and seamed material selectively form an enclosed three-dimensional pocket with the necessary volume, shape and contour to accommodate the nose from the Dorsal Area to the Apex of the nose. An arched shaped bendable metal structure spans the nose pocket and attaches on both sides of the nose pocket to provide adjustability for different sized and shaped noses. Supporting ear loops are attached before and after the ears on both sides of the upper edge of the mask as additional securing means.

### FIELD OF THE INVENTION

The invention relates to a face mask that is adapted for use in environments where particulates need to be filtered from the air before the air is breathed.

### BACKGROUND OF THE INVENTION

A variety of dust mask designs are known. For example, U.S. Pat. No. 8,056,560 (“Wilcox”) shows a dust mask that fits over the mouth and under the nose. U.S. Pat. No. 4,300,240 (“Edwards”) shows a cold weather mask with an area contoured over the nose. This contoured area has an open breathing aperture for the nostrils. U.S. Des. Pat. No. D636,128 (“Hancock”) shows an ornamental design for a dust mask. U.S. Pat. No. 6,718,982 (“Smith”) shows a respiratory monitor apparatus that uses a primary and secondary strap system to attach the mask member to the wearer's face. It also shows the use of a malleable metal clip to make the mask better conform to the bridge of the wearer's nose. U.S. Pat No. 9,067,086 (“Danford”) shows a training mask with an outer attachment mask that has inner cutouts for seating around and behind the wearer's ears.

There are many environments where an individual may find it desirable and or necessary to filter particulates from the air before the air is breathed. These types of environments may be encountered during a wide variety of activities and by a wide range of people. As a result of this need, there are various masks designed to filter the air for the comfort and safety of the wearer. Activities that expose people to these types of environments can range in duration from a few minutes to multiple hours.

A significant determining factor in whether a mask gets used is the overall comfort of the mask. Current mask designs put uncomfortable pressure on the wearer's nose because of at least three factors. First, the two-dimensional nose area in current masks is an incorrect shape for the three-dimensional nose to fit comfortably. Typically, resilient fabric is used to compensate so it can stretch to fit the nose. This stretching puts the mask under tension and in turn puts pressure on the sensitive bridge of the nose. Because the two-dimensional shape doesn't fit the three-dimensional nose correctly, it also creates a negative cavity between the nose and the cheekbone which needs to be sealed. A flexible metal clip is typically used to help the material further stretch down into the cavity between the bridge of the nose and the cheekbone putting additional pressure on the sensitive nose bridge area. Second, current mask designs have a seam that runs down the center of the nose that creates additional pressure points. Third, the mask is continually pulling down on the nose because the straps are fastened on the inward sloping part of the back of the wearers head. The mask continually wants to move downward putting corresponding pressure on the nose because it is the highest and most forward part of the front of the mask.

For these masks to be effective, generally they must provide a tight seal around the perimeter of the face. The most challenging area to seal around is the area between the nose and cheekbone. Frequently, a negative cavity will exist in this area. If this gap is not closed, it will permit unfiltered air to flow past the mask and reduce the effectiveness of the filtering.

Many methods have been used to facilitate the sealing of the mask around the face. One of the most prevalent designs is a mask made of fabric which is demonstrated in the Smith patent. This shows a mask constructed from two separate pieces of material sewn together to form the mask and a pocket to seal around the face of the wearer. A metal clip is fixedly attached to the material covering the bridge of the nose in an attempt to close the negative cavity between the nose and cheekbone. The clip rests directly over the nose and is designed to press the mask fabric material directly to the bridge of the nose, creating pressure on the bridge of the nose. For the mask to be effective it must also be comfortable for the wearer during its use, particularly with extended use over multiple hours. To be comfortable, it must closely fit the wearers face and compensate for variations in shapes and sizes of facial features. The nose area is the most problematic area for proper fit and comfort. This is because current fabric masks are constructed using two-piece, two-dimensional designs to accommodate a three-dimensional facial feature. The malleable metal clips being used today are also designed to work with existing two-dimensional designs. To close the negative cavity and seal the mask, these clips can put a tremendous amount of pressure over a small area at the bridge of the nose and cause discomfort. This excessive pressure on the bridge of the nose is one of the main reasons why a wearer cannot utilize existing masks for extended periods of time.

Another problematic area of current masks is their method of attachment. It is common for the front part of the mask to be held under tension with straps that are wrapped around the user's head and fastened together behind the user's head. The single strap is performing two functions: (1) sealing the mask and (2) holding the mask in position on the face. The shape of the back of the human head is generally inward sloping from the middle of the skull to the base of the skull where it attaches to the neck. This is the area where the strap is typically fastened together. Because of this inward slope, the strap will continually want to slide down the inward slope. This downward sliding action puts a tremendous amount of pressure on the front upper portion of the mask. The highest point as well and the most forward point at the front of the mask is the nose area. This is where the most pressure from the sliding action is felt. Again, increased pressure on the bridge of the nose is created, limiting the effectiveness of existing masks.

The Smith patent attempts to resolve this by utilizing an upper strap so that two straps are secured behind the wearer's head, but the upper strap is still located on the rounded portion on the head so the strap still wants to slip down. The two straps may provide more holding power, but they will always want to slide down the rounded shape on the back of the head. In actuality, the upper strap just adds additional pressure that is transferred to the face, usually the bridge of the nose, of the wearer, meaning the mask becomes more uncomfortable. Additionally, the mask in the Smith patent cannot be used in conjunction with the use of any headwear as the headwear will push the upper strap out of position, which in turn pushes the whole mask out of position.

The Danford patent shows rear attachment straps with cutouts for seating around the wearer's ears. This method of attachment still places the attachment point on the negative sloped area at the back of the head. In addition, the stretching of the fabric to put the mask under tension deforms the ear cutouts to a narrowed shape that pinches and puts pressure on the ears of the wearer, which leads to discomfort for the wearer.

### SUMMARY OF THE INVENTION

To solve the existing problems with known face masks, the present invention provides an improved fit and function face mask that allows a user to comfortably wear the mask without excessive pressure being placed on the face of the user.

Another object of this invention is to provide an improved fit and function face mask that allows a user to comfortably wear the mask without excessive pressure being placed on the nose of the user.

Another object of this invention is to provide an improved fit and function face mask that allows a user to comfortably wear the mask for an extended period of time without excessive pressure being placed on the face of the user.

Another object of this invention is to provide an improved fit and function face mask that provides a three-dimensional nose pocket that reduces pressure on the wearer's nose and dramatically improves comfort.

Another object of this invention is to provide an improved fit and function face mask that allows for variations in the size and shape of the nose of individual wearers.

Another object of this invention is to provide an improved fit and function face mask that allows the user to seal the negative cavity area between the nose and the cheekbones without adding pressure to the nose of the user.

Another object of this invention is to provide an improved fit and function face mask that permits the user to position and hold the mask in place without adding additional pressure to the face of the user.

Another object of this invention is to provide an improved fit and function face mask that does not rely solely on being secured at the rounded portion of the back of the user's head.

To the accomplishment of the above and related aspects, the invention may be embodied in the form illustrated in the accompanying drawings. The drawings, however, are illustrative only. Variations are contemplated as being part of the invention, limited only by the scope of the claims.

### BRIEF DESCRIPTION OF THE DRAWINGS

FIG. 1 is a perspective view of the side of the invention.

FIG. 2 is a perspective view of the interior of the invention.

FIG. 3 is a perspective view of the invention being worn by a user.

FIG. 4 is a perspective view of the three-dimensional nose pocket of the invention.

FIG. 5 is a front view of the the invention.

### DETAILED DESCRIPTION OF THE INVENTION

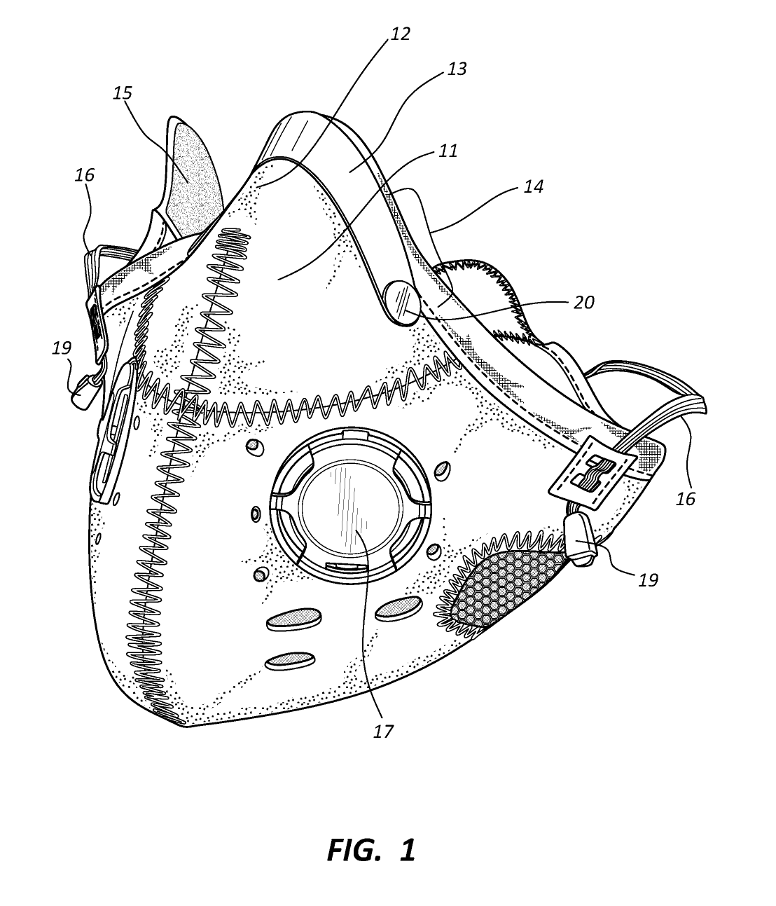

FIG. 1 shows the improved fit and function face mask 10 of the present invention. Three-dimensional nose pocket 11 is created by using a separate piece of material to allow for the proper shape, volume and contour for a more anatomical fit around an individual's nose. The top of three-dimensional nose pocket 11 contains seamless area 12, which eliminates pressure points on the nose of the wearer and increases comfort for the wearer. The smooth contoured shape of three-dimensional nose pocket 11 and seamless area 12 are selectively formed to naturally follow the shape of the nose without unnecessary pressure. Arched malleable nose clip 13 is selectively formed and spans three-dimensional nose pocket 11 attaching on either side of three-dimensional nose pocket 11 to allow the user to adjust the mask to cover the negative cavity areas 14 between the bridge of the nose and cheekbones of the wearer. Arched malleable nose clip 13 only attaches at its ends 20 to improved fit and function face mask 10 and does not attach across seamless area 12 of three-dimensional nose pocket 11. This allows the improved fit and function face mask 10 to be adjusted specifically in the negative cavity areas 14 without putting additional pressure on the sensitive nose bridge area of the wearer. The arched shape also spreads any pressure needed to conform improved fit and function face mask 10 evenly along both sides of the nose. By adjusting arched malleable nose clip 13, the wearer can ensure that improved fit and function face mask 10 sits comfortably across the wearer's nose and also closes off the negative cavity areas 14 between the bridge of the wearer's nose and cheekbones, thus preventing dust from getting past improved fit and function face mask 10. Arched malleable nose clip 13 does not put any pressure on the nose of the wearer.

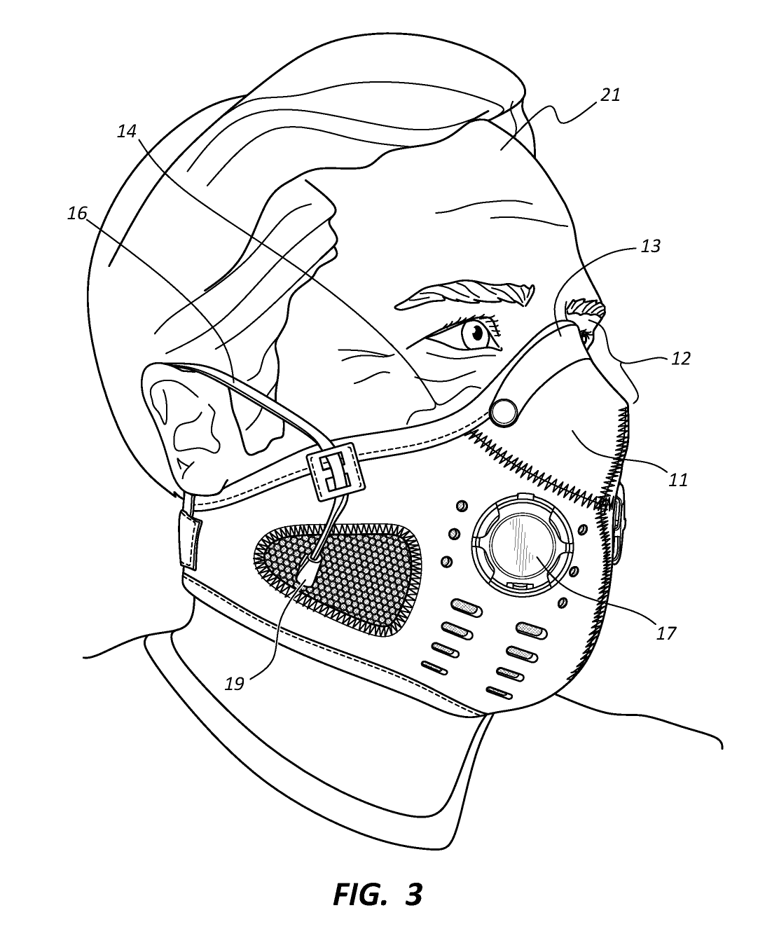

Attachment strap 15 is secured behind the head of the wearer to provide initial placement of improved fit and function face mask 10 on the wearer's face. It does this by holding improved fit and function face mask 10 on the wearer's face and providing enough pressure on improved fit and function face mask 10 to seal it around the wearer's face. Because of the natural shape of most wearer's heads, adjustable strap 15 may slip down and change the fit of improved fit and function face mask 10 on the wearer's face. To prevent that from happening, supporting ear loops 16 are placed over the wearer's ears to work with adjustable strap 15. Supporting ear loops 16 are designed to work with adjustable strap 15 but not rely on additional tension or attachment to the inwardly sloping back of the wearer's head or across the wearer's face. Supporting ear loops 16 are adjustable and are attached to the upper edge of improved fit and function face mask 10 on either side of the wearer's ears. In order to accommodate the user who wears improved fit and function mask while wearing a helmet or other head covering, ear loop adjustment tabs 19 are located in a forward position. The user adjusts supporting ear loops 16 up and over both ears as shown in FIG. 3 where they serve to hold improved fit and function face mask 10 in the correct position on the wearer's face. Because supporting ear loops 16 prevent improved fit and function face mask 10 from moving downward, attachment strap 15 can be independently adjusted to apply only enough tension to properly seal improved fit and function face mask 10 to the wearer's face. The wearer inhales and exhales through one way exhaust valves 17 and filter media 18.

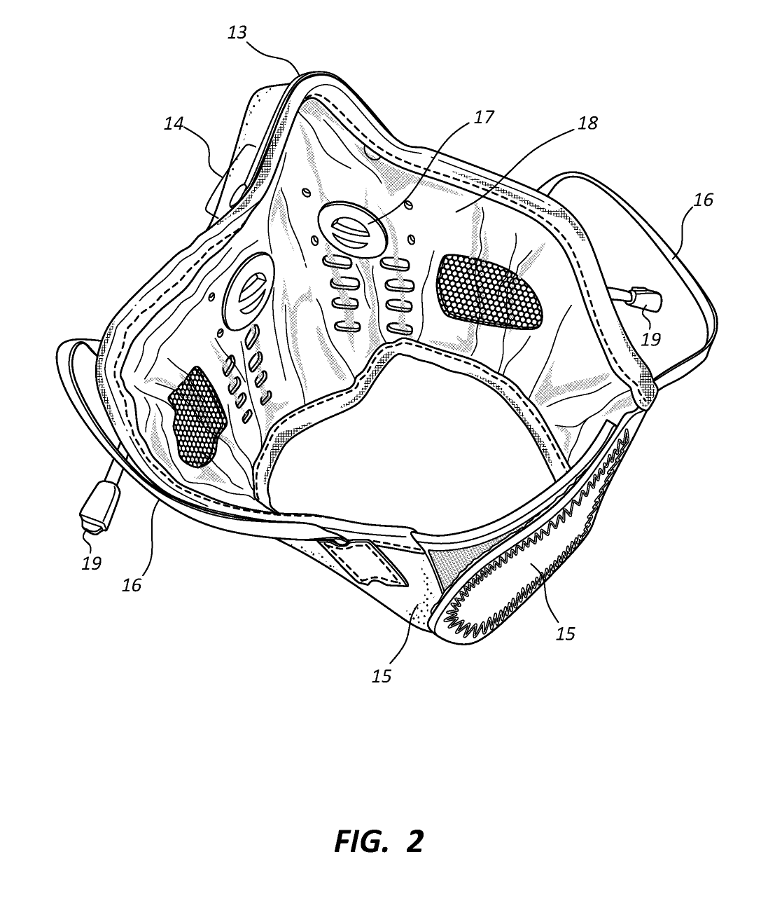

FIG. 2 shows the interior of improved fit and function face mask 10 with attachment strap 15 secured. Three-dimensional nose pocket 11 and arched malleable nose clip 13 are positioned to illustrate how they combine to allow a user to adjust improved fit and function face mask 10 so it fits comfortably on the user's face. Supporting ear loops 16 are placed over the wearer's ears and can be adjusted so that attachment strap 15 will not slide down the back of the wearer's head. The interior of improved fit and function mask 10 is lined with filter media 18, which serves to keep dust from coming through improved fit and function mask 10.

In FIG. 3, improved fit and function face mask 10 is shown being worn by a user 21. Three-dimensional nose pocket 11 is placed over the wearer's nose. Seamless area 12 runs from the dorsal area of the nose to the apex of the nose. Arched malleable nose clip 13 has been adjusted to seal off negative cavity areas 14. Arched malleable nose clip 13 and seamless area 12 ensure that minimal pressure will be placed on the wearer's nose, leading to increased comfort. Supporting ear loop 16 is seen in position over the wearer's ear and attachment strap 15 is secured at the back of the wearer's head. Supporting ear loop 16 prevents attachment strap 15 from sliding down the back of the wearer's head. Supporting ear loops 16 pull on improved fit and function face mask 10 is in a vertical or near-vertical direction and independent from the horizontal pull created by attachment strap 15. Supporting ear loops 16 are not used to attach the mask to the wearer's head, as is the case with simple surgical or other medical masks. Instead, supporting ear loops 16 are used to keep improved fit and function face mask 10 in the same vertical position on the face when it is being used. Without supporting ear loops 16, all the pressure to keep improved fit and function face mask 10 in place vertically is placed on the nose of the wearer, which is extremely uncomfortable.

Supporting ear loops 16 can be loosened or tightened without impacting attachment strap 15, and conversely, attachment strap 15 can be adjusted without impacting supporting ear loops 15. Attachment strap 15 controls the seal of improved fit and function face mask 10 on the face of the wearer while supporting ear loops 15 control the vertical or near-vertical movement of the mask on the wearer.

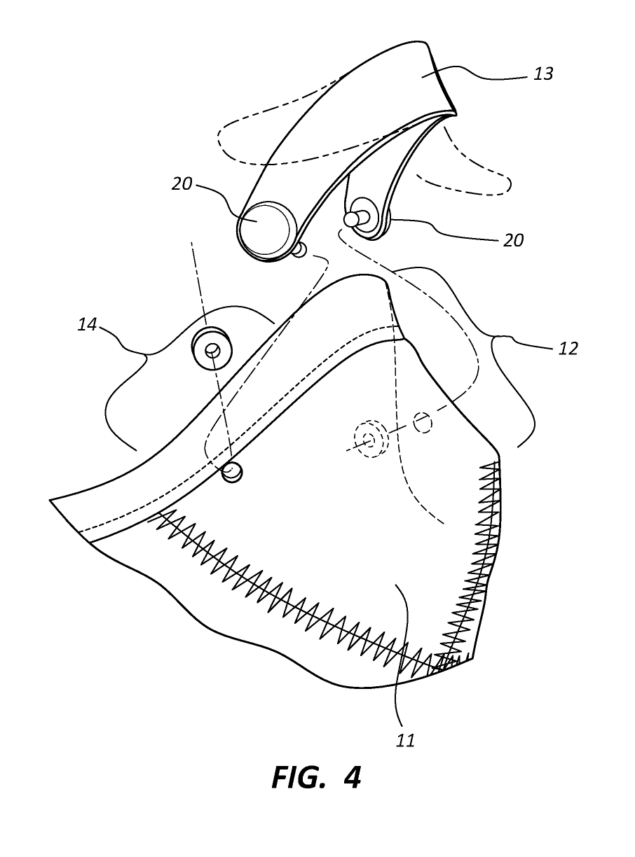

FIG. 4 provides a close-up view of three-dimensional nose pocket 11. Three-dimensional nose pocket 11 is formed by different pieces of material, and seamless area 12 ensures that minimal pressure will be place on the wearer's nose. Arched malleable nose clip 13 can be formed into an almost endless array of arch shapes to ensure proper fit over negative cavity areas 14. Arched malleable nose clip 13 is only attached at its ends 20 to increase comfort for the wearer.

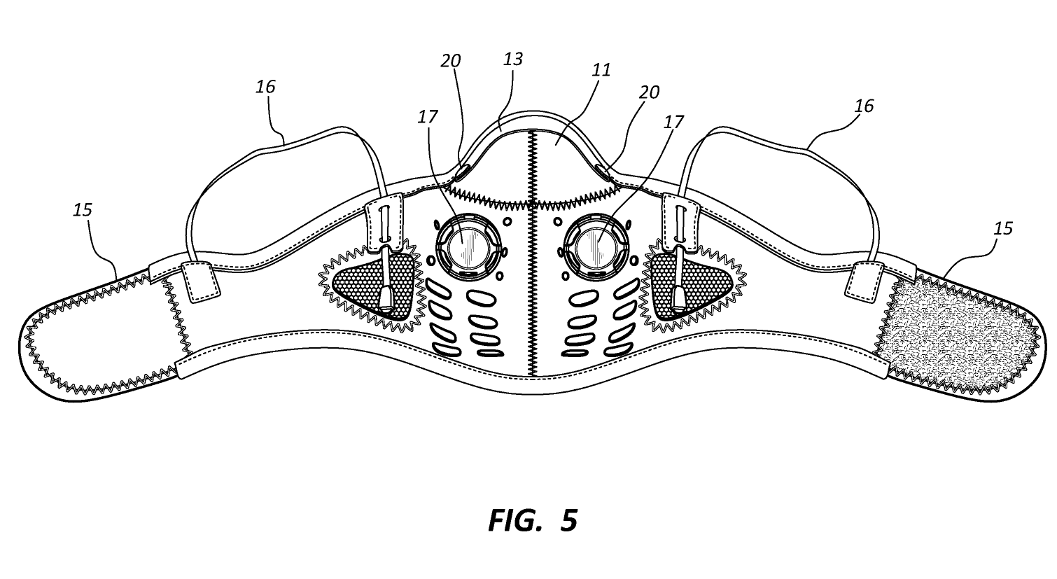

In FIG. 5, the entire span of improved fit and function mask 10 is shown. Three-dimensional nose pocket 11 is located at the center of improved fit and function device below arched malleable nose clip 13. The ends of attachment straps 15 are secured behind the head of a user and the comfort fit of the mask is adjusted using supporting ear loops 16. One way exhaust valves 17 are located near the user's mouth and nose area to allow for proper breathing by the user.

The description of the invention above should not be interpreted as limiting the invention to the disclosed embodiment because those who are skilled in the art to which the invention relates will be able to devise other equivalent forms thereof within the scope of the invention. Variations and changes, which are obvious to one skilled in the art, are intended to be within the scope and nature of the present invention.

What is claimed is:

1. An improved fit and function face mask comprising:
a mask member made of flexible material constructed to fit about the face of a human; and
a three-dimensional nose pocket constructed with a seamless area running from the dorsal area of the nose pocket to the apex of the nose pocket.

2. The improved fit and function face mask of claim 1 further comprising:
a seamed area below the apex of the nose pocket that is formed in combination with said seamless area to create an enclosed pocket that closely resembles the three-dimensional shape, volume and contour of the human nose.

3. The improved fit and function face mask of claim 2 further comprising:
an arched shaped malleable metal nose clip that spans said three-dimensional nose pocket and attaches at its ends to said mask member.

4. The improved fit and function face mask of claim 3 further comprising:
an attachment strap.

5. The improved fit and function face mask of claim 4 further comprising:
at least one independently adjustable ear loop attached to said mask member.

6. The improved fit and function face mask of claim 5 further comprising:
a filter media.

7. An improved fit and function face mask comprising:
a mask member made of flexible material constructed to fit about the face of a human;
a three-dimensional nose pocket constructed with a seamless area running from the dorsal area of the nose pocket to the apex of the nose pocket;
a seamed area below the apex of the nose pocket that is formed in combination with said seamless area to create an enclosed pocket that closely resembles the three-dimensional shape, volume and contour of the human nose;
an arched shaped malleable metal nose clip that spans said three-dimensional nose pocket and attaches at its ends to said mask member;
an attachment strap; and
at least one independently adjustable ear loop attached to said mask member.

8. The improved fit and function face mask of claim 7 further comprising:
a filter media.

9. An improved fit and function face mask comprising:
a mask member made of flexible material constructed to fit about the face of a human; and
at least one independently adjustable ear loop attached to said mask member
